(19) United States
(12) Patent Application Publication
(10) Pub. No.: US 2025/0158114 A1
(43) Pub. Date: May 15, 2025

(54) SOLID OXIDE ELECTROLYTES AND METHODS FOR MAKING THE SAME

(71) Applicant: Florida State University Research Foundation, Inc., Tallahassee, FL (US)

(72) Inventors: Yan-Yan Hu, Tallahassee, FL (US); Yudan Chen, Tallahassee, FL (US); Ifeoluwa Peter Oyekunle, Tallahassee, FL (US)

(21) Appl. No.: 18/945,762

(22) Filed: Nov. 13, 2024

Related U.S. Application Data
(60) Provisional application No. 63/599,060, filed on Nov. 15, 2023.

(51) Int. Cl. H01M 10/0562; C01G 25/00; H01M 10/0525

(52) U.S. Cl. CPC H01M 10/0562; C01G 25/006; H01M 10/0525; C01P 2002/50; C01P 2002/72; C01P 2002/76; C01P 2002/86; C01P 2006/40; H01M 2300/0071

(57) ABSTRACT

In accordance with the purpose(s) of the present disclosure, as embodied and broadly described herein, the disclosure, in one aspect, relates to solid oxide electrolytes and the low-temperature synthesis of solid oxide electrolytes. The electrolytes have the general formula LixMgMOy and have relatively high ionic conductivity and relatively good chemical stability. The electrolytes can be a component of different types of batteries. The process of synthesizing the electrolytes can be done under moderate conditions with cost-effective materials, which is useful for large-scale production.

### CROSS-REFERENCE TO RELATED APPLICATIONS

This application claims the benefit of and priority to co-pending U.S. Provisional Patent Application No. 63/599,060, filed on Nov. 15, 2023, the contents of which are incorporated by reference herein in their entireties.

### BACKGROUND

Over the past decade, all-solid-state batteries (ASSBs) have gained great interest as the next generation energy storage devices for their improved safety, better electrode compatibility, and higher energy densities, compared to the current lithium-ion batteries using liquid electrolytes. A solid electrolyte with high ionic conductivity, low-cost precursors, and good chemical stability is one important aspect of ASSBs. Three major categories of solid electrolytes have been studied extensively: sulfides, halides, and oxides. Sulfide- and halide-based solid electrolytes generally can have high ionic conductivity but poor chemical stability, while oxides have moderate ionic conductivity and good chemical stability. Nevertheless, the majority of these solid electrolytes require high synthesizing temperatures or expensive precursors, making it difficult for mass production and hindering the practice of ASSBs. Hence, high-performance solid electrolytes, which can be synthesized using cost-effective materials under moderate conditions, are important for the advancement of ASSBs.

### SUMMARY

In accordance with the purpose(s) of the present disclosure, as embodied and broadly described herein, the disclosure, in one aspect, relates to solid oxide electrolytes and the low-temperature synthesis of solid oxide electrolytes. The electrolytes have the general formula LixMgMOy and have relatively high ionic conductivity and relatively good chemical stability. The electrolytes can be a component of different types of batteries. The process of synthesizing the electrolytes can be done under moderate conditions with cost-effective materials, which is useful for large-scale production.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-11B (a) room-temperature electrochemical impedance spectroscopy Nyquist plots of LMZO pellets prepared at 700° C. with different lithium stuffing amount and (b) zoom-in Nyquist plots of the Li_{2.15}MgZrO_{4.075} and Li_{2.3}MgZrO_{4.15} trials.

FIGS. 2A-2C show room-temperature electrochemical impedance spectroscopy Nyquist plots of different Li_{2.15}MgZrO_{4.075} samples: Li_{2.15}MgZrO_{4.075} cold pressed pellet from the as-milled powders (FIG. 2A); Li_{2.15}MgZrO_{4.075} pellet heated at 700° C. for 6 hours (FIG. 2B); and Li_{2.15}MgZrO_{4.075} pellet heated at 1100° C. for 6 hours (FIG. 2C).

FIGS. 3A-3F show (a) powder X-ray diffraction pattern and the corresponding Rietveld refinement of the nominal Li_{2.15}MgZrO_{4.075}; (b) powder X-ray diffraction patterns of Li_{2.15}MgZrO_{4.075} prepared at 700° C. and 1100° C. and stoichiometry composition of ZrO₂ and Li₂MgZrO₄ from ICSD database; and (c) the tetragonal crystal structure (space group/4₁/amd) of Li_{2.15}MgZrO_{4.075} viewed from the b-direction. The structure shows (d) interconnected edge-sharing tetrahedra and (e) edge-sharing octahedra. (f) Li_{2.15}MgZrO_{4.075} structure viewed from the a-direction. The structure shows face-sharing octahedra and tetrahedra.

FIGS. 4A-4B show (a) the tetragonal crystal structure (space group/4₁/amd) of Li₂MgZrO₄ viewed from the b-direction and (b) the structure of Li₂MgZrO₄ revealing only edge-sharing octahedra without bridging tetrahedral site.

FIGS. 5A-5B show high-resolution ⁶Li NMR analysis of Li_{2.15}MgZrO_{4.075} trials: ⁶Li NMR spectra of samples prepared at 700° C. (blue) and 1100° C. (pink) (a) and deconvoluted ⁶Li NMR spectra of the 700° C. trial (b).

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an excipient” include, but are not limited to, mixtures or combinations of two or more such excipients, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Solid Oxide Electrolytes and Methods of Making and Using the Same

The present disclosure provides for solid oxide electrolytes and the method of making and using solid oxide electrolytes. The method of making can include low-temperature and cost-effective synthesis of solid oxide electrolytes. The electrolytes have the general formula LixMgMOy and can have relatively high ionic conductivity and relatively good chemical stability. The electrolytes can be included as a component of different types of batteries, such as solid-state batteries. Electrolytes with relatively high ionic conductivity and good chemical stability are useful components in solid-state batteries. Moderate synthesis conditions, such as lower heating temperatures, and low-cost precursors, such as earth abundant compounds, allows for more feasible mass production of solid-state batteries.

In one aspect, the electrolytes have the formula LiₓMgMO_{y}, where M can be one of Al, Y, Sc, Zr, Hf, or Ta; x can be from about 1.000 to about 3.750 or about 1.0, 2.0, 3.0, or 3.5, where any value can be a lower and upper endpoint of a range (e.g., 1.0 to 3.0); and y can be from about 3.000 to about 5.375 or about 3.0, 4.0, 5.0, or 5.3, where any value can be a lower and upper endpoint of a range (e.g., 3.0 to 5.3). In a further aspect, the electrolyte is not Li₂MgZrO₄.

In other aspects, M can be one of Al, Y, or Sc; x can be from about 1.000 to about 1.250 or about 1.0, 1.1, or 1.2, where any value can be a lower and upper endpoint of a range (e.g., 1.0 to 1.1); and y can be from about 3.000 to about 3.125 or about 3.00, 3.05, or 3.10, where any value can be a lower and upper endpoint of a range (e.g., 3.00 to 3.05). In other aspects, M can be one of Zr or Hf; x can be from about 2.00 to about 2.50 or about 2.1, 2.2, 2.3, 2.4, or 2.5, where any value can be a lower and upper endpoint of a range (e.g., 2.2 to 2.5); and y can be from about 4.00 to about 4.25 or about 4.00, 4.10, 4.15, 4.20, or 4.25, where any value can be a lower and upper endpoint of a range (e.g., 4.10 to 4.20). In yet other aspects, M can be Ta; x can be from about 3.00 to about 3.75 or about 3.0, 3.2, 3.4, 3.6, or 3.75, where any value can be a lower and upper endpoint of a range (e.g., 3.2 to 3.4); and y can be from about 5.00 to about 5.375 or about 5.0, 5.1, 5.2, 5.3, or 5.375, where any value can be a lower and upper endpoint of a range (e.g., 5.1 to 5.3).

In other aspects, the electrolyte can have the formula LixMgMOy, where M is Zr; x can be from about 2.00 to about 2.50 or about 2.1, 2.3, 2.4, or 2.5, where any value can be a lower and upper endpoint of a range (e.g., 2.3 to 2.5); and y can be from about 4.00 to about 4.25 or about 4.00, 4.10, 4.15, 4.20, or 4.25, where any value can be a lower and upper endpoint of a range (e.g., 4.10 to 4.20). In other aspects, the electrolyte can be one of Li_{2.15}MgZrO_{4.075}, Li_{2.3}MgZrO_{4.15}, or Li_{2.5}MgZrO_{4.25}. In a further aspect, the electrolyte can be Li_{2.15}MgZrO_{4.075}.

The electrolytes disclosed herein can be characterized by various properties. In one aspect, the electrolytes disclosed herein can have relatively high ionic conductivity. The electrolytes can have an ionic conductivity of at least about 0.50 mS/cm. In other aspects, the electrolytes can have an ionic conductivity of about 0.50 mS/cm to about 0.70 mS/cm or about 0.50 mS/cm, 0.60 mS/cm, or 0.70 mS/cm, where any value can be a lower and upper endpoint of a range (e.g., 0.60 mS/cm to 0.70 mS/cm). In further aspects, the electrolytes have an ionic conductivity of about 0.54 mS/cm. In another aspect, the electrolytes can be conductive over a temperature range of about −20° C. to about 100° C. or about −20° C., 0° C., 20° C., 40° C., 60° C., 80° C., or 100° C., where any value can be a lower and upper endpoint of a range (e.g., 0° C. to 40° C.). Exemplary methods for determining ionic conductivity are provided in the Examples.

In some aspects, the electrolytes have a cation-disordered metastable face-sharing phase in the crystal structure. This structure can include octahedral (Oₕ) lithium sites, tetrahedral (T_{d}) lithium sites, and a mixture of Oₕ and T_{d} lithium sites. In some aspects, at least one T_{d} lithium site bridges or connects two adjacent Oₕ lithium sites.

The electrolytes described herein have unique X-ray diffraction (XRD) patterns. In some aspects, the X-ray powder diffractions can be performed using an X-ray wavelength of 1.5406 Å. The electrolytes can have an X-ray powder diffraction pattern including peaks at 28.2°, 30.2°, 31.5°, 34.1, 35.9°, 37.0°, 39.7°, 42.7°, 49.3°, 50.3°, 54.9°, 57.5°, 59.7°, 61.9°, 62.3°, 69.6°, 73.6°, 74.7°, 76.1°, and 78.6°±0.2° 2θ. In other aspects, the electrolytes can have an X-ray powder diffraction pattern including peaks at 35.9°, 39.7°, and 42.7°±0.2° 2θ or ±0.1° 2θ. In other aspects, the electrolytes can have an X-ray powder diffraction pattern including peaks at 28.2°, 31.50, 35.9°, 39.7°, and 42.7°±0.2° 2θ or ±0.1° 2θ.

The electrolytes described herein also possess unique solid-state NMR spectra. In one aspect, the electrolytes can have peaks at about −0.06 ppm and about 0.38 ppm as determined by ⁶Li solid-state NMR spectroscopy. Exemplary methods for performing XRD and NMR measurements are provided in the Examples.

Disclosed herein are methods for making the electrolytes in a cost-effective manner, which is critical for large-scale production. In one aspect, disclosed is a method for making solid oxide electrolytes having the formula LiₓMgMO_{y}, where M can be one of Al, Y, Sc, Zr, Hf, or Ta; x can be from about 1.000 to about 3.750 or about 1.0, 1.5, 2.0, 2.5, 3.0, or 3.5, where any value can be a lower and upper endpoint of a range (e.g., 1.0 to 3.0); and y can be from about 3.000 to about 5.375 or about 3.0, 3.5, 4.0, 4.5, or 5.0, where any value can be a lower and upper endpoint of a range (e.g., 3.5 to 4.0). The method includes mixing a plurality of precursor compounds, such as salts, in various amounts in the solid state and heating the mixture to produce the electrolytes. In one aspect, the compounds are mixed together in stoichiometric amounts. The compounds mixed together can include LiA selected from the group including LiOH, Li₂CO₃, and Li₂O, MgD selected from the group including MgO, MgCO₃, and Mg(OH)₂, and MO selected from the group including Al₂O₃, Y₂O₃, Sc₂O₃, HfO₂, ZrO₂, Ta₂O₅, and any combination thereof, to produce a first mixture. In other aspects, the compounds mixed together can include LiOH, MgO, and MO selected from the group including Al₂O₃, Y₂O₃, Sc₂O₃, HfO₂, ZrO₂, Ta₂O₅, and any combination thereof, to produce a first mixture.

The compounds used to produce the electrolytes described herein are generally highly pure materials. In one aspect, each of the compounds has a purity of greater than 99%, greater than 99.5%, or greater than 99.9%. In one aspect, each compound used to produce the electrolytes are substantially anhydrous, where each compound is at least 95% moisture free, at least 98% moisture free, at least 99% moisture free, at least 99.9% moisture free, or 100% moisture free. In another aspect, each compound has less than 0.5 ppm water, less than 0.25 ppm water, or less than 0.1 ppm water.

In another aspect, the compounds can be mixed by mechanochemical milling. Mixing of the compounds can occur in a mixing jar or container using one or more balls to produce a complex motion that combines back-and-forth swings with short lateral movements. In one aspect, the compounds are mixed with one another for at least two hours, less than two hours, or less than one hour. In another aspect, the compounds are mixed from about 15 minutes to about 45 minutes or about 15 minutes, 20 minutes, 25 minutes, 30 minutes, 35 minutes, 40 minutes, or 45 minutes, where any value can be a lower and upper endpoint of a range (e.g., 25 minutes to 35 minutes). In one aspect, the compounds are mixed in an inert atmosphere such as, for example, nitrogen or argon. In one aspect, the inert atmosphere has less than 0.5 ppm oxygen, less than 0.25 ppm oxygen, or less than 0.1 ppm oxygen. In some aspects, the mixture is further dried after mixing.

After mixing, the mixture can be pelletized. The pellets or mixture can be heat treated at temperatures of at about 500° C. to about 900° C. or 500° C., 600° C., 700° C., 800° C., or 900° C., where any value can be a lower and upper endpoint of a range (e.g., 600° C. to 800° C.). The heat treatment can be from about 4 hours to about 8 hours or 4 hours, 5 hours, 6 hours, 7 hours, or 8 hours, where any value can be a lower and upper endpoint of a range (e.g., 6 hours to 8 hours). In other aspects, the pellets or mixture can be heat treated at temperatures of about 700° C. for about 6 hours.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

Aspect 1. A compound having the formula LiₓMgMO_{y}, wherein
M is selected from the group consisting of Al, Y, Sc, Zr, Hf, Ta, and any combination thereof;
x is from about 1.000 to about 3.750; and
y is from about 3.000 to about 5.375,
wherein the compound is not Li₂MgZrO₄.

Aspect 2. The compound of Aspect 1, wherein M is selected from Al, Y, and Sc.

Aspect 3. The compound of Aspect 2, wherein x is from about 1.000 to about 1.250 and y is from about 3.000 to about 3.125.

Aspect 4. The compound of Aspect 1, wherein M is selected from Zr and Hf.

Aspect 5. The compound of Aspect 4, wherein x is from about 2.00 to about 2.50 and y is from about 4.00 to about 4.25.

Aspect 6. The compound of Aspect 1, wherein M is Ta.

Aspect 7. The compound of Aspect 6, wherein x is from about 3.00 to about 3.75 and y is from about 5.00 to about 5.375.

Aspect 8. The compound of Aspect 1, wherein M is Zr, x is from about 2.00 to about 2.50, and y is from about 4.00 to about 4.25.

Aspect 9. The compound of Aspect 1, wherein the compound is one of Li_{2.15}MgZrO_{4.075}, Li_{2.3}MgZrO_{4.15}, or Li_{2.5}MgZrO_{4.25}.

Aspect 10. The compound of Aspect 1, wherein the compound is Li_{2.15}MgZrO_{4.075}.

Aspect 11. The compound of any one of Aspects 1-10, wherein the compound has an ionic conductivity of at least 0.50 mS/cm.

Aspect 12. The compound of any one of Aspects 1-10, wherein the compound has an ionic conductivity of about 0.50 mS/cm to about 0.70 mS/cm.

Aspect 13. The compound of any one of Aspects 1-10, wherein the compound is conductive over a temperature range of about −20° C. to about 100° C.

Aspect 14. The compound of any one of Aspects 1-10, wherein the compound has a cation-disordered metastable face-sharing structure.

Aspect 15. The compound of Aspect 14, wherein at least one tetrahedrally coordinated lithium ion bridges at least two octahedrally coordinated lithium ions.

Aspect 16. The compound of any one of Aspects 1-10, wherein the compound has an X-ray powder diffraction pattern comprising peaks at 35.9°, 39.7°, and 42.7°±0.2° 2θ as measured by X-ray powder diffractions using an X-ray wavelength of 1.5406 Å.

Aspect 17. The compound of any one of Aspects 1-10, wherein the compound has an X-ray powder diffraction pattern comprising peaks at 28.2°, 31.5°, 35.9°, 39.7°, and 42.7°±0.1° 2θ as measured by X-ray powder diffractions using an X-ray wavelength of 1.5406 Å.

Aspect 18. The compound of any one of Aspects 1-10, wherein the compound has peaks at about −0.06 ppm and 0.38 ppm as determined by ⁶Li solid-state NMR spectroscopy.

Aspect 19. A method for making a compound having the formula LiₓMgMO_{y}, wherein M is selected from the group consisting of Al, Y, Sc, Zr, Hf, and Ta;
x is from about 1.000 to about 3.750; and
y is from about 3.000 to about 5.375,
the method comprising:
(a) mixing in the solid state (i) LiA selected from the group consisting of LiOH, Li₂CO₃, and Li₂O; (ii) MgD selected from the group consisting of MgO, MgCO₃, and Mg(OH)₂; and (iii) MO selected from the group consisting of Al₂O₃, Y₂O₃, Sc₂O₃, HfO₂, ZrO₂, Ta₂O₅, and any combination thereof, to produce a first mixture and
(b) heating the first mixture to produce the compound.

Aspect 20. The method of Aspect 19, wherein LiA, MgD, and MO are substantially anhydrous.

Aspect 21. The method of Aspect 19 or 20, wherein LiA, MgD, and MO are mixed in stoichiometric amounts.

Aspect 22. The method of any one of Aspects 19-21, wherein LiA, MgD, and MO are mixed by mechanochemical milling.

Aspect 23. The method of any one of Aspects 19-22, wherein LiA, MgD, and MO are mixed in an inert atmosphere.

Aspect 24. The method of any one of Aspects 19-23, wherein the first mixture is produced by mixing LiOH, MgO, and MO, selected from the group consisting of Al₂O₃, Y₂O₃, Sc₂O₃, HfO₂, ZrO₂, Ta₂O₅, and any combination thereof.

Aspect 25. The method of any one of Aspects 19-24, wherein the first mixture is heated at a temperature of about 500° C. to about 900° C.

Aspect 26. The method of any one of Aspects 19-24, wherein the first mixture is heated at a temperature of about 600° C. to about 800° C.

Aspect 27. The method of any one of Aspects 19-24, wherein the first mixture is heated at a temperature of about 700° C.

Aspect 28. The method of any one of Aspects 19-27, wherein the first mixture is heated from about 4 hours to about 8 hours.

Aspect 29. A compound produced by the method of any one of Aspects 19-28, wherein the compound is not Li₂MgZrO₄.

Aspect 30. A battery comprising the compound in any one of Aspects 1-18 and 29.

Aspect 31. The battery of Aspect 30, wherein the battery is a solid-state battery.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Materials and Methods

### Synthesis

Lithium hydroxide (98%, Sigma Aldrich), magnesium oxide (97%, Sigma Aldrich), and zirconium oxide (99%, Sigma Aldrich) were vacuumed and dried at 120° C. for 12 hours. The precursors were mixed stoichiometrically in a 25 mL zirconia jar with 1.5 mL acetone and two 10-mm I.D. zirconia balls. High energy mechanochemical mixing of the precursors was performed using an 8000M mixer/mill (SPEX SamplePrep) for 2 hours. As-milled powders were dried at 80° C. for 1 hour. Samples were pelletized by cold pressing under 1200 psi. The pellets were heat treated at 700° C. for 6 hours in vacuum and followed by natural cooling.

### Electrochemical Impedance Measurement

Indium thin discs were used as the blocking electrodes in the In|LMZO|In symmetrical cells. The ionic conductivity of the LMZO pellets was determined from the electrochemical impedance spectroscopy (EIS) obtained using a Gamry Analyzer Reference 600+ with a frequency range of 5 MHz to 1 Hz and an AC voltage of 10 mV rms.

### Powder X-Ray Diffraction (XRD)

Samples were grinded to fine powders and loaded on a zero-background sample holder.

XRD was performed using a Rigaku Smartlab Powder X-ray diffractometer with Bragg-Brentano geometry at 44 kV and 40 mA with Cu-Kα radiation (λ=1.5406 Å). The X-ray diffraction pattern was collected in the 26 position range from 10° to 80° at 2.5°/min with a step size of 0.03°.

### Solid-State NMR

⁶Li and ⁷Li magic-angle-spinning (MAS) NMR of LMZO was acquired using a Bruker Advance-III 500 MHz spectrometer (11.7 T) with a spinning rate of 23 kHz. The Larmor frequencies are 73.3 MHz for ⁶Li and 194.4 MHz for ⁷Li. Single pulse ⁶Li and ⁷Li NMR experiments were conducted with pulse lengths of 6.5 μs and 3.4 μs, and with recycle delays of 80 s and 20 s respectively. ⁶Li and ⁷Li chemical shifts were calibrated with LiCl(s) at −1.1 ppm.

### Results and Discussion

The Li₂MgZrO₄ crystal was first synthesized in 1985 by solid-state reaction of Li₂ZrO₃ and MgO with heating at 1320 K for 24 hours.¹⁵ The final product is a partially disordered rock-salt (α-LiFeO₂) which has Mg and Zr disordered over the Fe sites, while the Li arrangement is ordered. In the stoichiometric composition, even if the two adjacent lithium octahedrons (Oₕ) have a shared edge, the distance between the two lithium slabs is large, leading to a high energy barrier for Li Oₕ-Oₕ jumping and thereby a relatively low ionic conductivity. By inserting or extracting lithium to a DRX structure, the oxidation state of the transition metal species will be varied to compensate the change difference, which induces dimensional changes of the overall structure due to Jahn-Teller distortion on the transition metal sites. As a result, the spacing between the two lithium Oₕ sites will be altered and a reduction in the Li⁺ hopping between two Oₕ sites can be achieved by controlling the lithium amount.¹⁶ Furthermore, an intermediate lithium tetrahedral site (T_{d}) between two adjacent lithium octahedral sites can be made, in which the lithium migration energy barrier is significantly lowered in the Oₕ-T_{d}-Oₕ pathway.¹⁷ This suggests that the lithium stuffing amount and the temperature need to be optimized to obtain the face-sharing species of the cation-disordered LMZO.

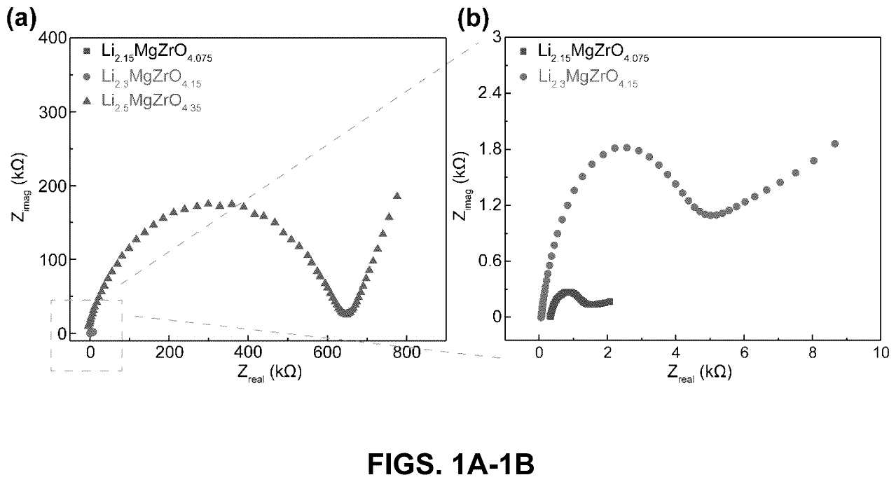

Theoretically, the maximum lithium stuffing amount in the DRX is 25%. Synthesis of the lithium-stuffed LMZO is performed using high-energy mechanochemical ball milling of the precursors for the Li_{2.15}MgZrO_{4.075}, L_{2.3}MgZrO_{4.15}, and Li_{2.5}MgZrO_{4.25}, followed by heat treatment at 700° C. as described in the experimental section. FIG. 1 displays the Nyquist plots of the ionic conductivity of the three LMZO compositions, from which the total impedance (bulk+grain boundary) is determined by fitting with the equivalent circuit model. The total ionic conductivity is calculated using the equation

$$( σ = \frac{l}{A \times R} ) ,$$

where σ denotes the total ionic conductivity, l is the thickness of the LMZO pellet, A is the area of the indium blocking electrode, and R is the total impedance. The calculated total ionic conductivity at room temperature is 0.54 mS/cm, 0.09 mS/cm, and 7.4×10⁻⁴ mS/cm for Li_{2.15}MgZrO_{4.075}, L_{2.3}MgZrO_{4.15}, and Li_{2.5}MgZrO_{4.25} respectively. With increasing lithium content, the ionic conductivity decreases, indicating that 7.5% is the optimal lithium stuffing amount for LMZO electrolyte, in which the maximum tetrahedral intermediate face-sharing lithium sites are obtained and lithium-ion percolation is promoted.

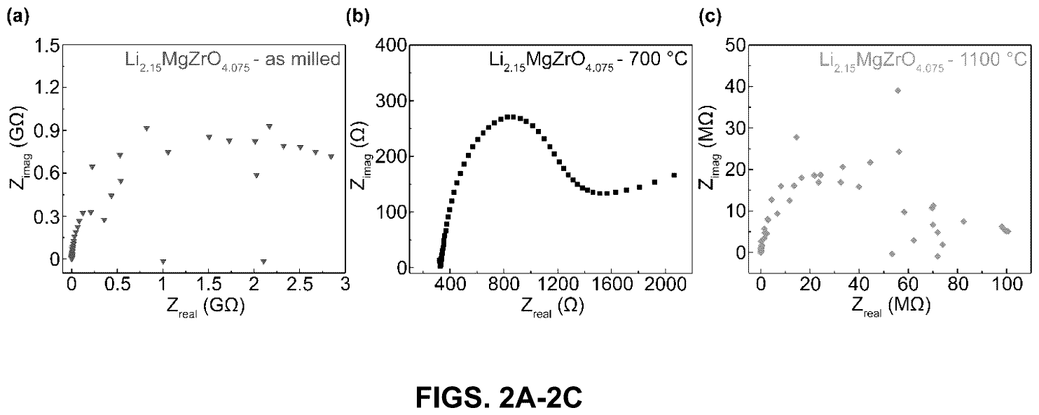

The effect of temperature on the electrochemical properties and crystalline structure of the Li_{2.15}MgZrO_{4.075} is also investigated. The as-milled sample shows almost no ionic conduction, indicating that the solid-state reaction is not complete by using mechanochemical high-energy ball milling only (FIG. 2a). Heating is still required to initiate the phase transition of the milled sample, especially for oxide materials. When the sample is heated at 700° C., a relatively small total impedance of 1500 ohm is achieved (FIG. 2b).

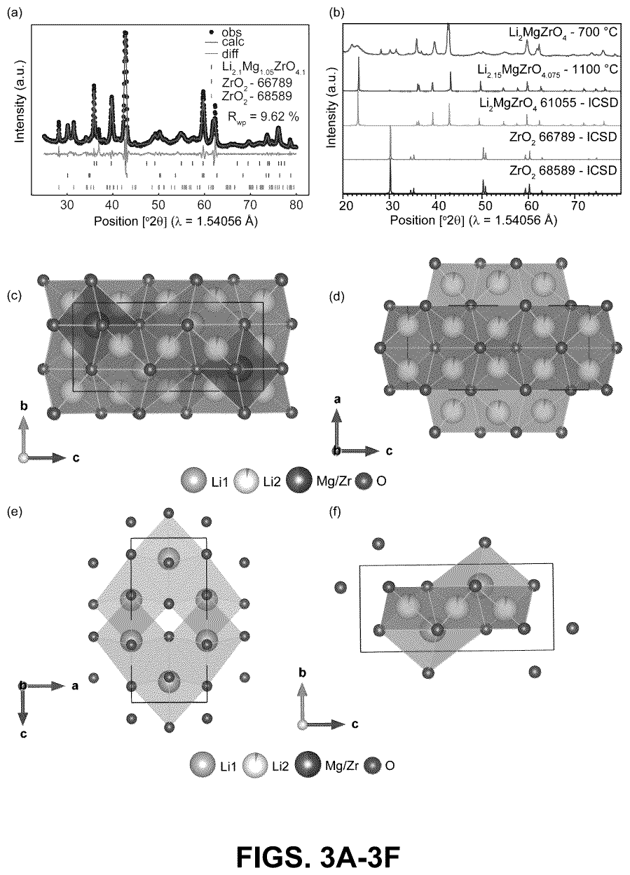

The Rietveld refinement analysis (FIG. 3a) and XRD pattern (FIG. 3b) of Li_{2.15}MgZrO_{4.075} (700° C.) reveals the presence of disordered rock salt Li₂MgZrO₄ (α-LiFeO₂) as the major crystalline phase. Rietveld refinement was performed on the powder XRD data to determine the bulk structural parameters, including atomic coordinates, site occupancies, and thermal factors. The resulting diffractograms (FIG. 3a) can be indexed to a tetragonal/4₁/amd space group, consistent with lab powder XRD observations. However, ZrO₂ phase accounts for ˜7.8 wt % of the phase fraction. The ZrO₂ impurity is likely to be from unreacted precursors and contamination from the ball milling process. The structural visualization in FIG. 3f reveals three possible Li⁺ transport pathways viz—tetrahedral to tetrahedral (tet-tet) site (FIG. 3d), octahedral to octahedral (oct-oct) site (FIG. 3e) and octahedral through a bridging tetrahedral to an octahedral (oct-tet-oct) site (FIG. 3f). However, the high Li-ion conductivity suggests the face-sharing Li configuration as the most probable pathway. The presence of face-sharing Tet-Oct Li polyhedra in Li_{2.15}MgZrO_{4.075} is consistent with the data obtained from solid-state NMR experiment.

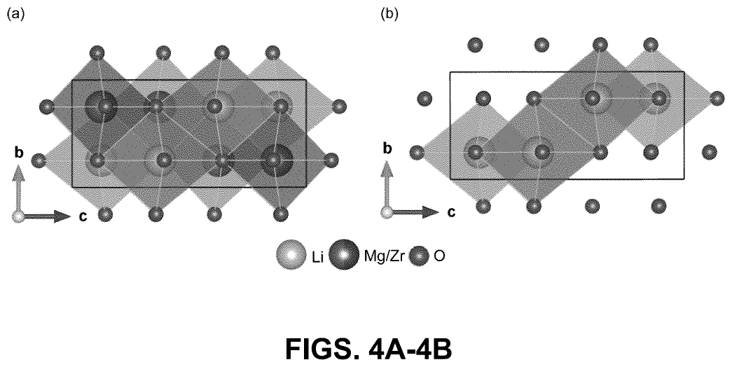

When a high temperature of 1100° C. is applied to the Li_{2.15}MgZrO_{4.075} sample, a pure disordered rock salt Li₂MgZrO₄ (α-LiFeO₂) is obtained (FIG. 3) but with a large total impedance (FIG. 2c). In this case, no “bridging” lithium tetrahedral sites are present (FIG. 4 a,b) and thereby the energy barrier of ion hopping between the two adjacent lithium octahedral sites is quite large, leading to a poor ionic conduction.

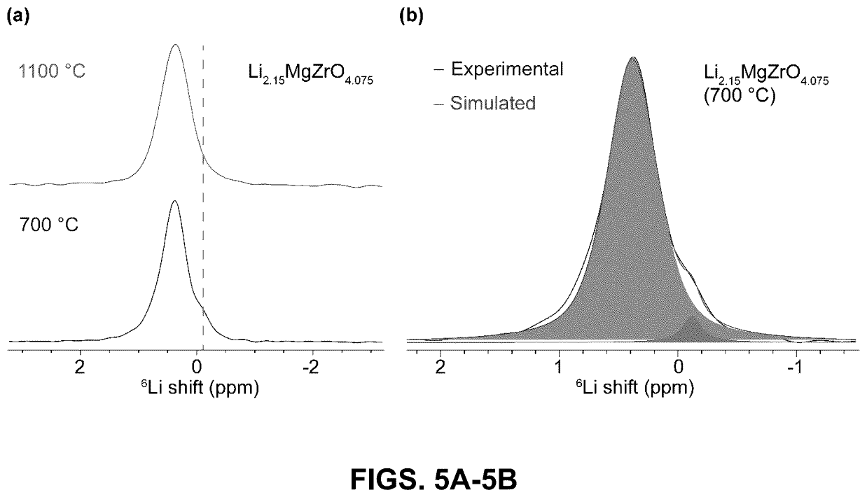

High-resolution ⁶Li NMR is employed to investigate the lithium environment in the Li_{2.15}MgZrO_{4.075} sample. FIG. 5a shows the ⁶Li NMR spectrums of Li_{2.15}MgZrO_{4.075} prepared at 700° C. and 1100° C. The spectrum of the 1100° C. sample displays only one resonance at 0.38 ppm, which is assigned to the Li in the octahedral site in the disordered rock salt (α-LiFeO₂) structure. ⁶Li NMR of the 700° C. trial shows two components resonating at 0.38 ppm and −0.06 ppm, assigned to Li in octahedral site and Li in intermediate tetrahedral site respectively. The amount of each Li component in the 700° C. sample is determined from the deconvolution of the ⁶Li NMR spectrum as shown in FIG. 5c, which contains around 96% of octahedral site Li and 4% of tetrahedral site Li. The ⁶Li NMR analysis indicates that the appearance of the Li tetrahedral site (face-sharing with the adjacent Li octahedral sites) is responsible for improved Li⁺ ion conduction, in which the energy barrier for Li migration is significantly reduced in the Li_{Oct}-Liₜₑₜᵣₐ-Li_{oct} pathway.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

(1) Tarascon, J.-M.; Armand, M. Issues and Challenges Facing Rechargeable Lithium Batteries. Nature 2001, 414, 359-367. https://doi.org/10.1038/35104644.
(2) Armand, M.; Tarascon, J.-M. Building Better Batteries. Nature 2008, 451, 652-657. (3) Bachman, J. C.; Muy, S.; Grimaud, A.; Chang, H.-H.; Pour, N.; Lux, S. F.; Paschos, O.; Maglia, F.; Lupart, S.; Lamp, P.; Giordano, L.; Shao-Horn, Y. Inorganic Solid-State Electrolytes for Lithium Batteries: Mechanisms and Properties Governing Ion Conduction. Chem. Rev. 2016, 116 (1), 140-162. https://doi.org/10.1021/acs.chemrev.5b00563.
(4) Zhao, Q.; Stalin, S.; Zhao, C.-Z.; Archer, L. A. Designing Solid-State Electrolytes for Safe, Energy-Dense Batteries. Nat Rev Mater 2020, 5 (3), 229-252. https://doi.org/10.1038/s41578-019-0165-5.
(5) Reddy, M. V.; Julien, C. M.; Mauger, A.; Zaghib, K. Sulfide and Oxide Inorganic Solid Electrolytes for All-Solid-State Li Batteries: A Review. Nanomaterials 2020, 10 (8), 1606. https://doi.org/10.3390/nano10081606.
(6) Combs, S. R.; Todd, P. K.; Gorai, P.; Maughan, A. E. Designing Defects and Diffusion through Substitutions in Metal Halide Solid Electrolytes. J. Electrochem. Soc. 2022, 169 (4), 040551. https://doi.org/10.1149/1945-7111/ac5bad.
(7) Jonderian, A.; McCalla, E. The Role of Metal Substitutions in the Development of Li Batteries, Part II: Solid Electrolytes. Mater. Adv. 2021, 2 (9), 2846-2875. https://doi.org/10.1039/D1 MA00082A.
(8) Amores, M.; Ashton, T. E.; Baker, P. J.; Cussen, E. J.; Corr, S. A. Fast Microwave-Assisted Synthesis of Li-Stuffed Garnets and Insights into Li Diffusion from Muon Spin Spectroscopy. J. Mater. Chem. A 2016, 4 (5), 1729-1736. https://doi.org/10.1039/C5TA08107F.
(9) Samson, A. J.; Hofstetter, K.; Bag, S.; Thangadurai, V. A Bird's-Eye View of Li-Stuffed Garnet-Type Li 7 La 3 Zr 2 O 12 Ceramic Electrolytes for Advanced All-Solid-State Li Batteries. Energy Environ. Sci. 2019, 12 (10), 2957-2975. https://doi.org/10.1039/C9EE01548E.
(10) Arbi, K.; Mandal, S.; Rojo, J. M.; Sanz, J. Dependence of Ionic Conductivity on Composition of Fast Ionic Conductors Li 1+x Ti 2-xAlx(PO4)3, 0≤x≤0.7. A Parallel NMR and Electric Impedance Study. Chem. Mater. 2002, 14 (3), 1091-1097. https://doi.org/10.1021/cm010528i.
(11) O'Callaghan, M. P.; Powell, A. S.; Titman, J. J.; Chen, G. Z.; Cussen, E. J. Switching on Fast Lithium Ion Conductivity in Garnets: The Structure and Transport Properties of Li 3+x Nd 3 Te 2-xSbxO12. Chem. Mater. 2008, 20 (6), 2360-2369. https://doi.org/10.1021/cm703677q.
(12) Jun, K.; Sun, Y.; Xiao, Y.; Zeng, Y.; Kim, R.; Kim, H.; Miara, L. J.; Im, D.; Wang, Y.; Ceder, G. Lithium Superionic Conductors with Corner-Sharing Frameworks. Nat. Mater. 2022, 21 (8), 924-931. https://doi.org/10.1038/s41563-022-01222-4.
(13) Wang, Y.; Richards, W. D.; Ong, S. P.; Miara, L. J.; Kim, J. C.; Mo, Y.; Ceder, G. Design Principles for Solid-State Lithium Superionic Conductors. Nature Mater 2015, 14 (10), 1026-1031. https://doi.org/10.1038/nmat4369.
(14) Urban, A.; Lee, J.; Ceder, G. The Configurational Space of Rocksalt-Type Oxides for High-Capacity Lithium Battery Electrodes. Adv. Energy Mater. 2014, 4 (13), 1400478. https://doi.org/10.1002/aenm.201400478.
(15) Castellanos, M.; West, A. R.; Reid, W. B. Dilithium Magnesium Zirconium Tetraoxide with an α-LiFeO2 Structure. Acta Crystallogr C Cryst Struct Commun 1985, 41 (12), 1707-1709. https://doi.org/10.1107/S0108270185009155.
(16) Van Der Ven, A.; Bhattacharya, J.; Belak, A. A. Understanding Li Diffusion in Li-Intercalation Compounds. Acc. Chem. Res. 2013, 46 (5), 1216-1225. https://doi.org/10.1021/ar200329r.
(17) Lee, J.; Urban, A.; Li, X.; Su, D.; Hautier, G.; Ceder, G. Unlocking the Potential of Cation-Disordered Oxides for Rechargeable Lithium Batteries. Science 2014, 343 (6170), 519-522. https://doi.org/10.1126/science.1246432.
(18) Doebelin, N.; Kleeberg, R. Profex: A Graphical User Interface for the Rietveld Refinement Program BGMN. J Appl Crystallogr 2015, 48 (5), 1573-1580. https://doi.org/10.1107/S1600576715014685.

1. A compound having the formula LiₓMgMO_{y}, wherein
M is selected from the group consisting of Al, Y, Sc, Zr, Hf, Ta, and any combination thereof;
x is from about 1.000 to about 3.750; and
y is from about 3.000 to about 5.375,
wherein the compound is not Li₂MgZrO₄.

2. The compound of claim 1, wherein M is selected from Al, Y, and Sc.

3. The compound of claim 2, wherein x is from about 1.000 to about 1.250 and y is from about 3.000 to about 3.125.

4. The compound of claim 1, wherein M is selected from Zr and Hf.

5. The compound of claim 4, wherein x is from about 2.00 to about 2.50 and y is from about 4.00 to about 4.25.

6. The compound of claim 1, wherein M is Ta.

7. The compound of claim 6, wherein x is from about 3.00 to about 3.75 and y is from about 5.00 to about 5.375.

8. The compound of claim 1, wherein M is Zr, x is from about 2.10 to about 2.50, and y is from about 4.00 to about 4.25.

9. The compound of claim 1, wherein the compound is one of Li_{2.15}MgZrO_{4.075}, Li_{2.3}MgZrO_{4.15}, or Li_{2.5}MgZrO_{4.25}.

10. The compound of claim 1, wherein the compound is Li_{2.15}MgZrO_{4.075}.

11. The compound of claim 1, wherein the compound has an ionic conductivity of at least 0.50 mS/cm.

12. The compound of claim 1, wherein the compound has an ionic conductivity of about 0.50 mS/cm to about 0.70 mS/cm.

13. The compound of claim 1, wherein the compound is conductive over a temperature range of about −20° C. to about 100° C.

14. The compound of claim 1, wherein the compound has a cation-disordered metastable face-sharing structure.

15. The compound of claim 14, wherein at least one tetrahedrally coordinated lithium ion bridges at least two octahedrally coordinated lithium ions.

16. The compound of claim 1, wherein the compound has an X-ray powder diffraction pattern comprising peaks at 35.9°, 39.7°, and 42.7°±0.2° 2θ as measured by X-ray powder diffractions using an X-ray wavelength of 1.5406 Å.

17. The compound of claim 1, wherein the compound has peaks at about −0.06 ppm and 0.38 ppm as determined by ⁶Li solid-state NMR spectroscopy.

18. A method for making a compound having the formula LiₓMgMO_{y}, wherein
M is selected from the group consisting of Al, Y, Sc, Zr, Hf, and Ta;
x is from about 1.000 to about 3.750; and
y is from about 3.000 to about 5.375,
the method comprising:
(a) mixing in the solid state (i) LiA selected from the group consisting of LiOH, Li₂CO₃, and Li₂O; (ii) MgD selected from the group consisting of MgO, MgCO₃, and Mg(OH)₂; and
(iii) MO selected from the group consisting of Al₂O₃, Y₂O₃, Sc₂O₃, HfO₂, ZrO₂, Ta₂O₅, and any combination thereof, to produce a first mixture and
(b) heating the first mixture to produce the compound.

19. A compound produced by the method of claim 18, wherein the compound is not Li₂MgZrO₄.

20. A battery comprising the compound of claim 1.
